(19) United States
(12) Patent Application Publication
(10) Pub. No.: US 2002/0078196 A1
(43) Pub. Date: Jun. 20, 2002

(54) Apparatus and method for dispersively processing QoS supported IP packet forwarding

(76) Inventors: Hyun-Cheol Kim, Taejon (KR); Jong-Arm Jeon, Taejon (KR); Kyou-Ho Lee, Taejon (KR); Hyeong-Ho Lee, Taejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/846,711

(22) Filed: Apr. 30, 2001

(30) Foreign Application Priority Data
Dec. 18, 2000 (KR) 2000-77852

(51) Int. Cl. G06F 15/16; G06F 15/173

(52) U.S. Cl. 709/224; 709/231

(57) ABSTRACT

In an apparatus and method for dispersively processing an IP packet forwarding for supporting a quality of service(QoS), an IP forwarding information base gotten by processing and extracting a routing protocol is dispersed to all input ports of a router on the basis of the QoS in a private network processor for performing a routing protocol process function, so as to dispersively process the IP packet forwarding. The method for dispersively processing the IP packet forwarding for supporting the QoS includes the steps of: a) classifying reception IP packets according to the QoS and storing them at an input-side class queue; b) searching the forwarding information base by using an exact matching table and an LPM (Longest Prefix Matching) search table according to an IP header value of the IP packet stored at the input-side class queue, and gaining forwarding information; c) transferring the IP packet according to the gained forwarding information; d) classifying the transferred IP packets according to the QoS, and storing them at an output-side class queue; and e) outputting the IP packet stored at the output-side class queue according to the QoS, whereby being used in the IP packet forwarding dispersion processing apparatus for supporting the quality of service, etc.

### FIELD OF THE INVENTION

The present invention relates to an apparatus and method for dispersively processing an IP packet forwarding for supporting a QoS, and a record medium capable of being read through a computer having a writing of a program to realize the inventive method; and more particularly, to an IP packet forwarding dispersion processing apparatus and method for effectively dispersion-processing an IP (Internet Protocol) forwarding function and a routing information base on the basis of a QoS (Quality of Service) within a system, and a record medium capable of being read through a computer having a writing of a program to realize the inventive method.

### DESCRIPTION OF THE PRIOR ART

In a conventional general router, a hierarchical 3 process function for forwarding an IP (Internet Protocol) packet is concentrated onto one functional block, thus in case there is much IP packet traffic to be forwarded, there is a problem such as a bottleneck phenomenon of traffic in a router.

Further, the conventional router provides a method for processing IP traffic at a high speed by using a new switching function, but does not provide an IP traffic processing method based on the QoS of the IP traffic.

### SUMMARY OF THE INVENTION

Therefore, it is an object of the present invention to provide an IP packet forwarding dispersion processing apparatus and method for dispersing an IP forwarding information base gotten by processing and extracting a routing protocol, to all input ports of a router, on the basis of a QoS in a private network processor for performing a routing protocol process function, so as to dispersively process an IP packet forwarding, and to also provide a record medium capable of being read through a computer having a writing of a program to realize the inventive method.

In accordance with the present invention for achieving the objects, an IP (Internet Protocol) packet forwarding dispersion processing apparatus for supporting a quality of service (QoS) includes an input processing unit for classifying reception IP packets according to the QoS and storing them at an input-side class queue; an information searching unit for searching a forwarding information base by using an exact matching table and an LPM (Longest Prefix Matching) search table according to an IP header value of the IP packet stored at the input processing unit, and gaining forwarding information; a packet transferring unit for transferring the IP packet according to the forwarding information gained through the information searching unit; and an output processing unit for classifying the IP packets transferred from the packet transferring unit according to the Qos, storing them at an output-side class queue, and outputting the stored IP packet according to the QoS (Quality of Service).

In addition, in the present invention, an IP (Internet Protocol) packet forwarding dispersion processing method applied to an IP packet forwarding dispersion processing apparatus for supporting a quality of service (QoS) includes the steps of: a) classifying reception IP packets according to the QoS and storing them at an input-side class queue; b) searching a forwarding information base by using an exact matching table and an LPM (Longest Prefix Matching) search table according to an IP header value of the IP packet stored at the input-side class queue, and gaining forwarding information; c) transferring the IP packet according to the gained forwarding information; d) classifying the transferred IP packets according to the QoS, and storing them at an output-side class queue; and e) outputting the IP packet stored at the output-side class queue according to the QoS.

Further, in the inventive IP packet forwarding dispersion-processing apparatus having a processor, it is provided a record medium capable of being read through a computer having a writing of a program to realize a first function of classifying reception IP packets according to the QoS and storing them at an input-side class queue; a second function of searching a forwarding information base by using an exact matching table and an LPM (Longest Prefix Matching) search table according to an IP header value of the IP packet stored at the input-side class queue, and gaining forwarding information; a third function of transferring the IP packet according to the gained forwarding information; a fourth function of classifying the transferred IP packets according to the QoS, and storing them at an output-side class queue; and a fifth function of outputting the IP packet stored at the output-side class queue according to the QoS.

### BRIEF DESCRIPTION OF THE DRAWINGS

The above and other objects and features of the instant invention will become apparent from the following description of preferred embodiments taken in conjunction with the accompanying drawings, in which:

FIG. 1 indicates a constructive exemplary diagram for an ATM-LAN backbone network using a QoS supported ATM-based high speed router in accordance with the present invention;

FIG. 2 illustrates a constructive exemplary diagram for an IP packet forwarding dispersion-processing apparatus in a QoS supported ATM-based high speed router in the present invention;

FIG. 3 is a block diagram of an Ethernet line input/output port processor in an IP packet forwarding dispersion-processing apparatus in the invention;

FIG. 4 is a block diagram of an ATM line input/output port processor in an inventive IP packet forwarding dispersion-processing apparatus;

FIG. 5 sets forth an explanatory diagram for an IP packet forwarding dispersion-processing procedure performed in respective line cards of an inventive QoS supported ATM-based high speed router;

FIG. 6 depicts an explanatory diagram for an IP packet forwarding dispersion-processing procedure of an inventive QoS supported ATM-based high speed router; and

FIG. 7 furnishes a flowchart for an IP packet forwarding dispersion-processing method in an inventive QoS supported ATM-based high speed router.

### PREFERRED EMBODIMENT OF THE INVENTION

Hereinafter, preferred embodiments of the present invention will be described in detail with reference to the accompanying drawings.

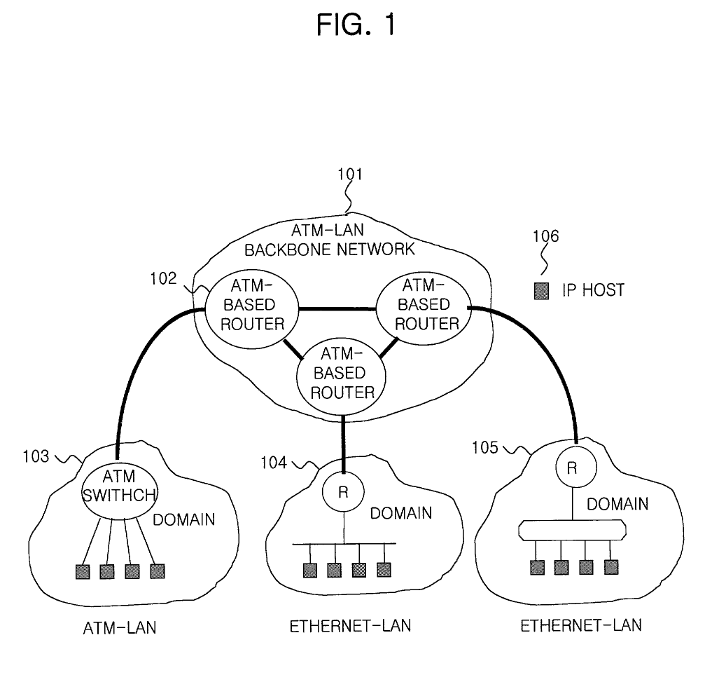

FIG. 1 is a constructive exemplary diagram for an ATM-LAN (Asynchronous Transfer Mode-Local Area Network) backbone network using a QoS supported ATM-based high speed router in accordance with the present invention, in other words, shows one example for the construction of an ATM-LAN backbone network 101 through a use of a router 102 using an ATM-based IP packet forwarding apparatus for supporting a QoS.

As shown in FIG. 1, the ATM-LAN backbone network 101 may be connected with various LAN domains such as an ATM-LAN 103 and an Ethernet-LANs 104, 105 network etc., and in the construction of such LAN domains 103, 104, 105, to support a smooth connection with an IP host 106 is the main function of the ATM-based router 102 for the ATM-LAN backbone network 101.

In order to provide such function, the ATM-based router 102 should basically have a routing protocol process function and an IP forwarding function contained into the existing router.

However, in a case of the existing LAN router for a backbone, the traffic amount to be processed in the router was not much relatively, in comparison with the amount of the inside traffic, thus the process could be executed by concentrating the IP forwarding function. But, according to a rapid increase of the IP traffic to be processed in a recent single backbone router, there is a problem that the IP forwarding function cannot be appropriately processed only with the concentrated IP forwarding processing system.

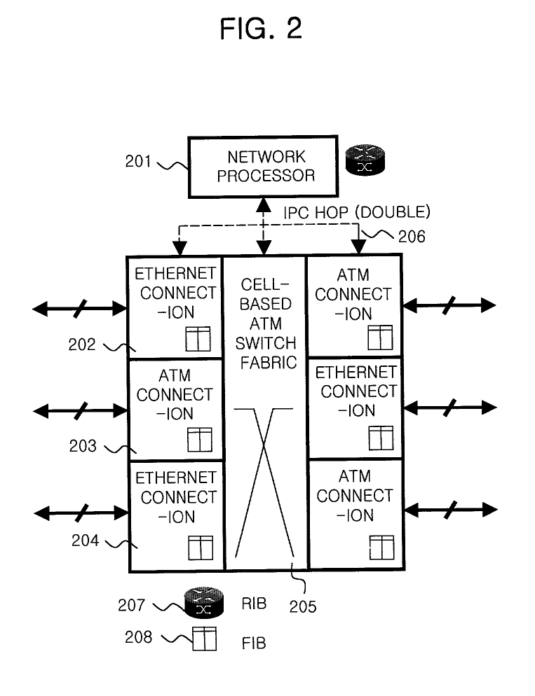

FIG. 2 is a constructive exemplary diagram for an IP packet forwarding dispersion-processing apparatus in a QoS supported ATM-based high speed router in the present invention.

As shown in FIG. 2, a routing protocol performing procedure in the QoS supported ATM-based router 102 is rapidly progressed by a real time through a specific network processor 201, for the sake of a rapid renewal of routing information and in order to maintain at maximum a synchronization between routers. In the network processor 201, a RIB (Routing Information Base) 207 representing next-hop information of an IP packet received is determined through a routing protocol execution, after that, it is performed a function of a transfer to a frame ATM connection 203 and an Ethernet connections 202, 204 card as respective line adaptation cards through a doubled IPC (Inter Processor Communication) hop 206.

Routing information between the network processor 201 and each of line connection cards 202, 203, 204 is transferred in a broadcast type on the IPC hop 206. The IPC hop 206 for transferring such important information is constructed by a doubled type to prevent a loss of the routing information and stabilize the routing information. All packets related to a routing protocol received from the respective line cards 202, 203, 204 are transferred to the network processor 201 through the IPC hop 206. Like this, for the sake of the packets to be transmitted to the IPC hop 206, a queue for it is provided in the respective line cards 202, 203, 204. The RIB 207 transferred to the respective line cards 202, 203, 204 is stored as an FIB (Forwarding Information Base) 208 as an IP look-up table type for performing an actual IP forwarding. In the respective line adaptation cards of the QoS supported ATM-based router 102, the IP packet received at a speed of a maximum line from the input port performs an effective IP look-up function by using the FIB 208. In FIG. 2, a cell based ATM switch fabric 205 receives an ATM cell based on a fixation length transferred from the ATM connection 203 and Ethernet connection 202, 204 cards as the line adaptation card, and performs a function of switching at a high speed.

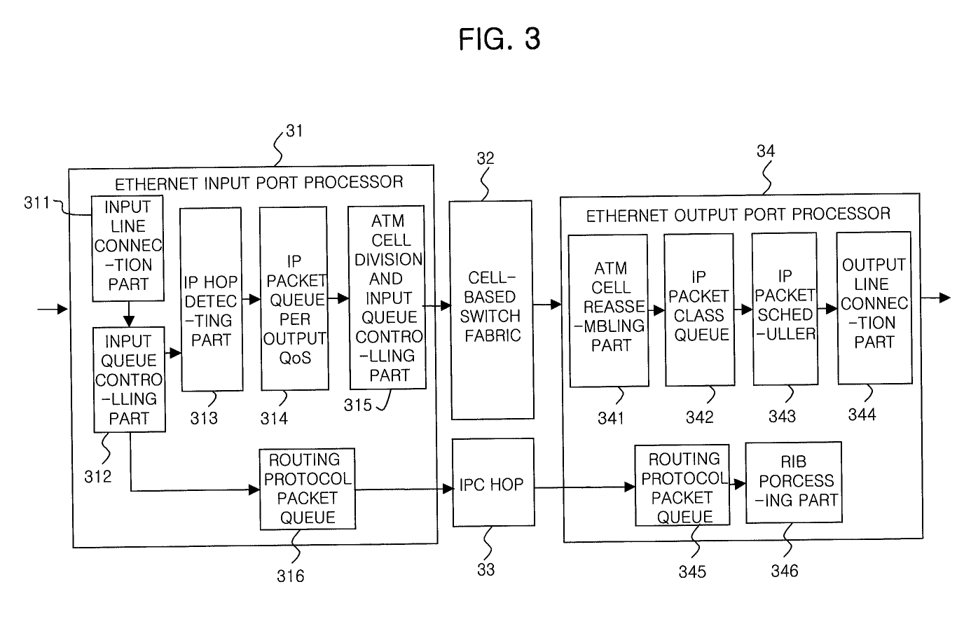

FIG. 3 is a block diagram of an Ethernet line input/output port processor in an IP packet forwarding dispersion-processing apparatus in the invention, and shows the Ethernet line input/output port processor of a QoS supported ATM-based high speed router.

As shown in FIG. 3, the inventive Ethernet line input/output port processor includes an Ethernet input port processor 31, a cell-based switch fabric 32, an IPC hop 33 and an Ethernet output port processor 34.

Herewith, the Ethernet input port processor 31 is composed of an input line connecting part 311 for separating an IP packet encapsulated into a frame of Ethernet media; an input queue controlling part 312 for storing a corresponding IP packet at a proper QoS queue according to header information of the IP packet separated from the input line connecting part 311; an IP hop detecting part 313 for reading the IP packet stored at a packet buffer by the input queue controlling part 312, through a weighted round robin system or a strict priority system, and searching an IP hop in order to find out a next-hop of a corresponding packet; an IP packet queue per output QoS 314 for storing the IP packet completed in a process of an IP header for the next-hop through the IP hop detecting part 313, per output port and QoS; an ATM cell division and input queue controlling part 315 for performing an access to the IP packet queue per output QoS 314 by the weighted round robin system or the strict priority system, executing a division into ATM cells, and then performing a transfer to a cell-based switch fabric 32; and a routing protocol packet queue 308 for storing a packet which is decided as a routing protocol by the input queue controlling part 312, and transferring it to the routing processor 201 through the doubled IPC hop 33.

Further, the Ethernet output port processor 34 is constructed by an ATM cell reassembling part 341 for reassembling ATM cells transferred from the cell-based switch fabric 32 and reproducing an IP packet; an IP packet class queue 342 for storing the IP packet received through the ATM cell reassembling part 341 according to a QoS of a corresponding packet; an IP packet scheduler 343 for scheduling the IP packet class queue 342 by the weighted round robin system or the strict priority system; an output line connection part 344 for encapsulating the IP packet into an Ethernet frame; a routing protocol packet queue 345 for storing a routing protocol frame received from the network processor 201 through the IPC hop 33, to transmit the routing protocol frame; and a RIB(Routing Information Base) processing part 346 for receiving a routing information base from the network processor 201 and converting it into a forwarding information base.

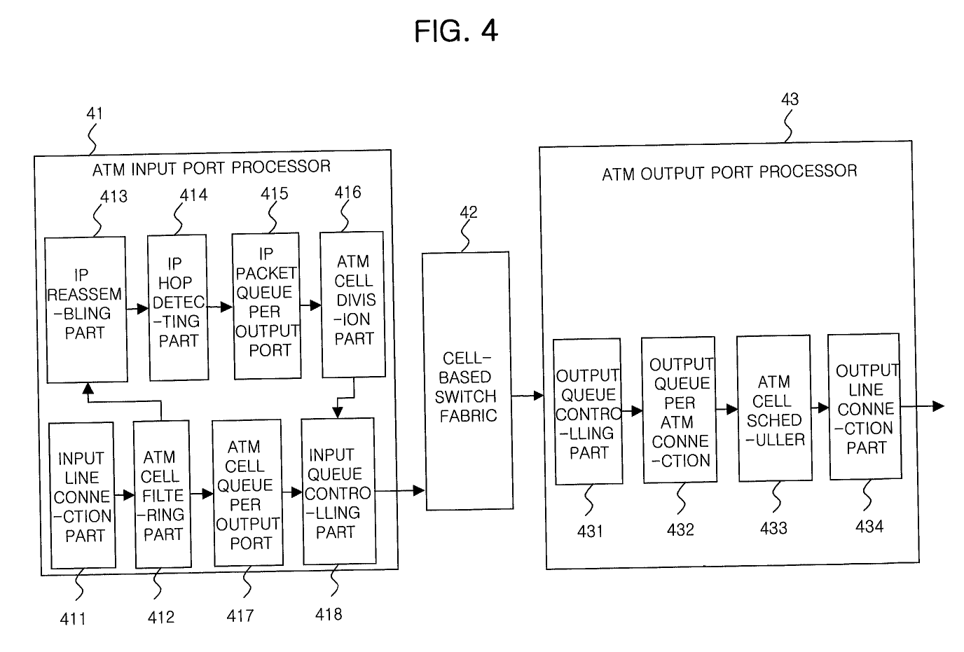

FIG. 4 is a block diagram of an ATM line input/output port processor in an inventive IP packet forwarding dispersion-processing apparatus, and represents the ATM line input/output port processor of the QoS supported ATM-based high speed router.

As shown in FIG. 4, the inventive ATM line input/output port processor contains an ATM input port processor 41, a cell-based switch fabric 42, and an ATM output port processor 43.

Herewith, the ATM input port processor 41 includes an input line connecting part 411 for extracting an ATM cell from an ATM transmission line frame, and connecting it to an input line; an ATM cell filtering part 412 for discriminating a cell required for an IP packet process and a cell required for only an ATM process, among the ATM cells received through the input line connection part 411, and filtering the discriminated cell; an IP reassembling part 413 for reassembling the cells transferred from the ATM cell filtering part 412 in an IP packet type; an IP hop detecting part 414 for searching an IP hop to find out a next-hop of an IP packet reassembled through the IP reassembling part 413; an IP packet queue per output port 415 for storing the IP packet completed in a process of an IP header for the next-hop through the IP hop detecting part 414, per output port; an ATM cell division part 416 for performing a sequential access to a queue per port through the IP packet queue 415 and executing a division into ATM cells; and an input queue controlling part 418 for performing an alternate access to the ATM cell queue per output port 415 for storing, per output port, the cell transferred from the ATM cell filtering part 412, the ATM cell division part 415 and the ATM cell queue per output port 417, and transferring the ATM cell to the cell-based switch fabric 42.

Also, the ATM output port processor 43 is constructed by an output queue controlling part 431 for storing an ATM cell transferred from the cell-based switch fabric 42 at an output queue per ATM connection, and controlling the stored ATM cell; an output queue per ATM connection 432 for storing cells according to a QoS per ATM connection; an ATM cell scheduler 433 for scheduling the cell stored at the output queue per ATM connection 432 according to the QoS per ATM connection; and an output line connection part 434 for transferring the ATM cell scheduled through the ATM cell scheduler 433 to an ATM transmission line frame, and connecting it to an output line.

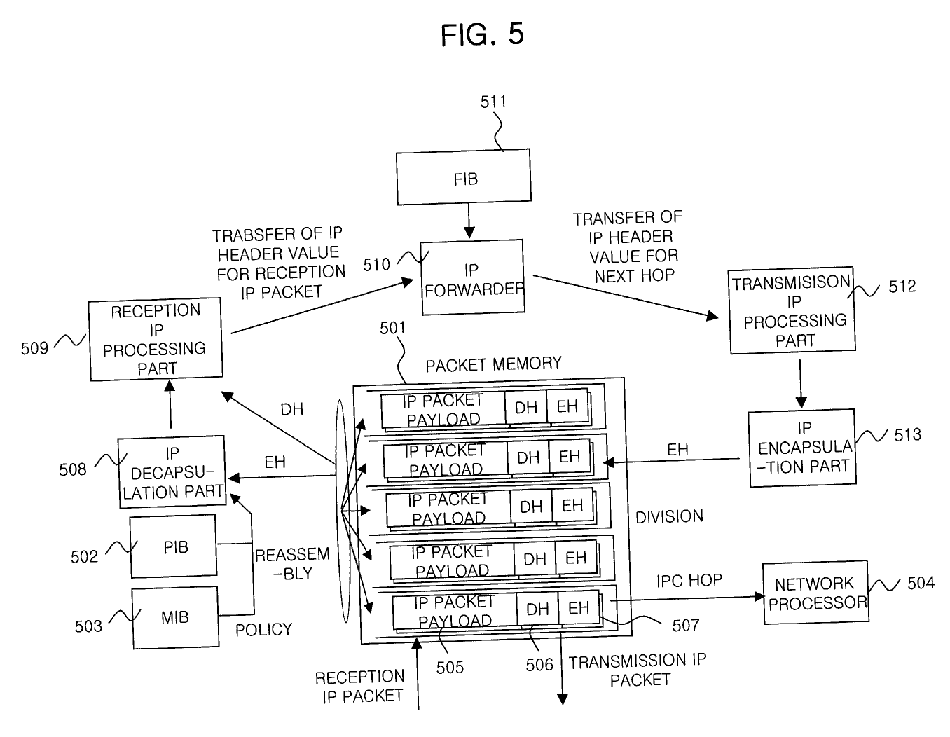

Detailed operations of respective constructive elements provided in FIGS. 3 and 4 are described as follows, referring to FIGS. 5 through 7.

FIG. 5 is an explanatory diagram for an IP packet forwarding dispersion-processing procedure performed in respective line cards of an inventive QoS supported ATM-based high speed router.

As shown in FIG. 5, the IP packets received through Ethernet media are not stored in sequence at a packet memory 501 inside in case that there is no error, but are stored at a corresponding independent queue according to a QoS of each IP packet. If the received packet is a routing protocol or there is a specific requirement in a PIB(Policy Information Base) 502 or an MIB(Monitoring Information Base) 503, the packet is stored at the independent queue for transferring it to the network processor 504.

Therefore, in the QoS supported ATM-based router system, the PIB 502 or the MIB 503 is used to monitor a flow of a specific packet or measure a status such as statistics of a specific IP. Since a time taken in storing the IP packet at the packet memory 501 and in reading it, is decisively influenced upon a high speed router operation and execution time, the packet memory 501 is constructed by using a high-speed SGRAM (Synchronous Graphic Random Access Memory) in the invention.

As the main fields of the IP packet stored within the packet memory 501, there are an IP packet payload 505, a DH(Destination Header) 506 as a destination IP address value of the IP packet, and an EH (Encapsulated Header) 507 as encapsulation header information stuck when the IP is encapsulated. In an IP decapsulation part 508, the stored IP packets are read by the weighted round robin system or the strict priority system, an EH 507 value among the read header information is analyzed, and then data to be transferred to a high reception IP processing part 509 is separated and transferred. Further, the IP decapsulation part 508 performs the function of decaying local traffic not going outside and transferring packets determined for a specific purpose such as a monitoring to a high rank.

Herewith, the reception IP processing part 509 catches the DH 506 value from the stored IP packet information, and transfers it to an IP forwarder 510 by a specific sequence per QoS requirement term. This IP forwarder 510 finds out IP address information for a next-hop by using the DH 506 value through a high-speed search for a FIB(Forwarding Information Base) 511 as an IP forwarding information table, and then transfers it to a transmission IP processing part 512.

Then, the transmission IP processing part 512 transfers an IP encapsulation value for next-hop IP address information to an IP encapsulation part 513. The IP encapsulation part 513 performs a function of replacing with a new EH 507 value containing a CRC (Cyclic Redundancy Code) so that the EH 507 value of the reception IP packet within the packet memory 501 can be appropriately processed in the next-hop. Such IP packet completed in the forwarding process for the IP header is transferred to the next-hop. As shown in the drawing, all the received IP packets excepting a routing protocol packet are processed without a specific copy from the packet memory 501, therefore the IP packet forwarding can be processed at a high speed.

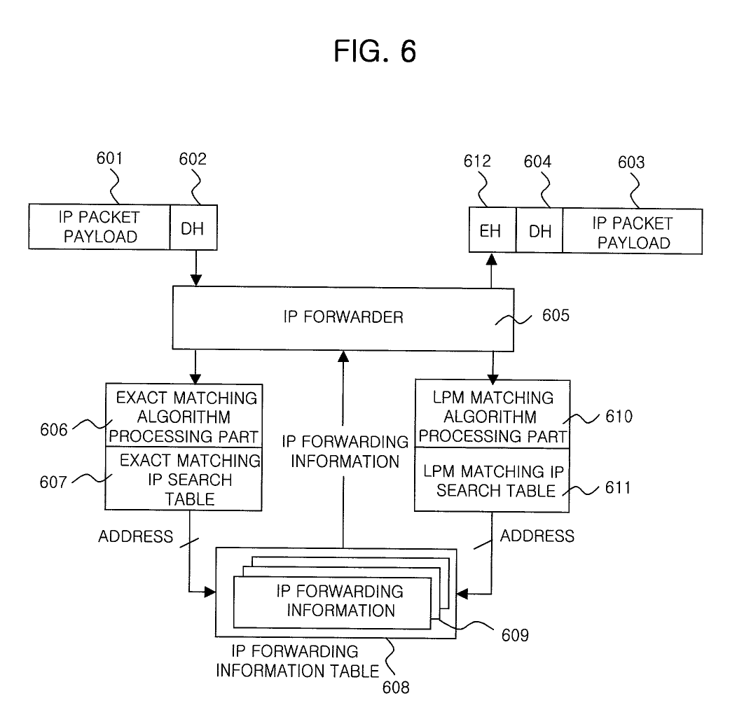

FIG. 6 is an explanatory diagram for an IP packet forwarding dispersion-processing procedure of an inventive QoS supported ATM-based high speed router.

As shown in FIG. 6, a payload 601 and a DH 602 of the IP packet received first are transferred as a payload 603 and a DH 604 of the transmission IP packet, without a specific change as it is. An IP forwarder 605 simultaneously sends the DH 602 value as a destination address of the reception IP packet to an exact matching algorithm processing part 606 and an LPM (Longest Prefix Matching) algorithm processing part 610.

At this time, the exact matching algorithm processing part 606 checks whether or not it is registered an entry same as the DH 602 value of the reception IP packet among entries of an exact matching IP search table 607. In case that the entry same as the DH 602 value of the reception IP packet is registered within the exact matching IP search table 607, a corresponding entry of the exact matching IP search table 607 outputs an address of an IP forwarding information table 608 at which encapsulation information for forwarding the reception IP packet is stored. Actually a commercial-use CAM (Content Addressable Memory) is used to perform such serial work.

Further, the LPM matching algorithm processing part 610 checks by repeatedly searching the table, whether or not it is registered an entry matched by the maximum length with the DH 602 value of the reception IP packet among entries of an LPM matching IP search table 611. A corresponding entry of the LPM matching IP search table 611 outputs an address of the IP forwarding information table 608 at which the encapsulation information for forwarding the reception IP packet is stored.

At this time, in case that the exact matching algorithm 606 is successfully performed, the IP forwarding information table 608 transfers the IP forwarding information 609 within the IP forwarding information table 608 to the IP forwarder 605, the IP forwarding information 609 corresponding to the address inputted from the exact matching IP search table 607. In case the exact matching algorithm 606 has a failure in its performance, the IP forwarding information table 608 transfers the IP forwarding information 609 within the IP forwarding information table 608 corresponding to the address inputted from the LPM matching IP search table 611, to the IP forwarder 605.

Herewith, the IP forwarder 605 constructs and transfers an encapsulation header value for encapsulating the IP packet by using the IP forwarding information 609 transferred from the IP forwarding information table 608. Also, in case the exact matching algorithm 606 has a failure, the IP forwarder 605 registers the address of the IP forwarding information table 608 as the result of the LPM matching algorithm processing part 610 and the DH 602 value of the reception IP packet, within the exact matching IP search table 607. In a case of the reception IP packets transferred successively, the IP packet can be forwarded at a high speed through the exact matching algorithm processing part 606.

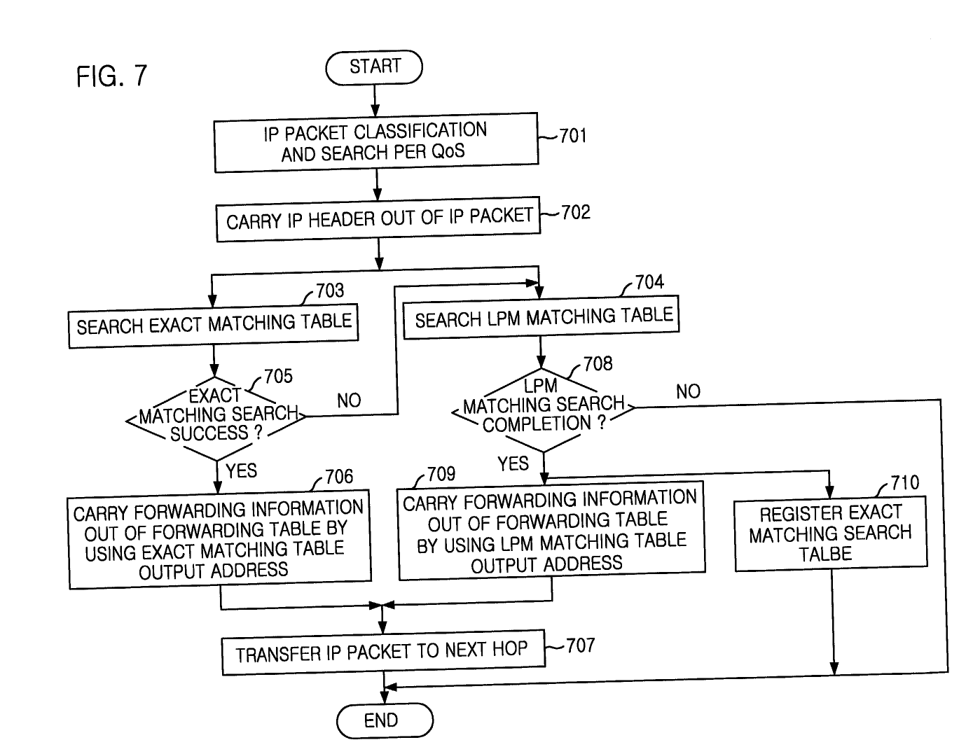

FIG. 7 is a flowchart for an IP packet forwarding dispersion-processing method in an inventive QoS supported ATM-based high speed router.

As shown in FIG. 7, in case the IP packets are received, the IP packets are first classified according to a QoS class which requires the IP packet and an IP packet hop is searched, in a step 701.

Primarily, an IP header value is gotten from the reception IP packet in a step 702, and then the exact matching table and the LPM search table are searched at the same time in steps 703 and 704, just, herewith the search is stopped if an exact matching search is successful in the midst of searching the LPM search table.

After that, it is clarified whether or not the exact matching search is performed successfully, in a step 705, and if the exact matching search is performed successfully, the forwarding information is carried out of the forwarding table by using an output address of the exact matching table in a step 706, after that, the IP packet is encapsulated and transferred to the next-hop in a step 707. If it fails in the exact matching search, a step 704 of searching the LPM search table is performed continuously in the step 704.

Subsequently, it is checked whether or not the LPM matching search work is completed, in a step 708, and in case that the LPM matching search work is completed without a cease, the forwarding information is carried out of the forwarding table by using the output address of the LPM matching table in a step 709, after that, the IP packet is encapsulated and transferred to the next-hop in the step 707, and simultaneously, the LPM matching result is registered for the exact matching search table in a step 710. Meantime, in case that the LPM matching work is stopped, the system is finished without a specific work.

The above-mentioned inventive method is embodied by a program, so as to be stored in a record medium such as CDROM, RAM, ROM, a floppy disk, a hard disk and an optical magnetic disk etc., which is capable of being read through a computer.

As afore-mentioned, in accordance with the present invention, an IP forwarding function and a routing information base are effectively dispersed and processed within a system on the basis of a QoS by using an ATM cell switching fabric based on a fixing length. That is, an IP forwarding information base, which is gotten by processing and extracting a routing protocol in a private network processor for performing a routing protocol process function, is dispersed to all input ports of the router on the basis of the QoS, thereby there is an effect of dispersing and processing an IP packet forwarding.

In addition, the present invention provides a packet QoS queue from an input line card to effectively process a packet requiring a real time QoS support.

QoS, and by preparing for a use case of a backbone network router or a high speed server, it can be also provided a port trunking function that traffic of specific input ports is bound by one in one line card and then is transferred to an output port. Accordingly, there is an effect of providing not only an ATM switch function as an original function of the existing ATM equipment, but also a function of a high speed ATM-based IP router.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for dispersively processing an IP (Internet Protocol) packet forwarding for supporting a quality of service (QoS), said apparatus comprising:
an input processing unit for classifying reception IP packets according to the QoS and storing them at an input-side class queue;
an information searching unit for searching a forwarding information base by using an exact matching table and an LPM (Longest Prefix Matching) search table according to an IP header value of the IP packet stored at the input processing unit, and gaining forwarding information;
a packet transferring unit for transferring the IP packet according to the forwarding information gained through the information searching unit; and
an output processing unit for classifying the IP packets transferred from the packet transferring unit according to the QoS, storing them at an output-side class queue, and outputting the stored IP packet according to the QoS.

2. The apparatus as recited in claim 1, wherein said information searching unit is characterized in that according to the searching result for the exact matching table, the forwarding information is carried out of the forwarding table by using an output address of the exact matching table, after that, the IP packet is encapsulated and transferred to a next-hop; and according to the searching result for the LPM matching table, the forwarding information is carried out of the forwarding table by using the output address of the LPM matching table, after that, the IP packet is encapsulated and transferred to the next-hop, and simultaneously, the LPM matching result is registered for the exact matching searching table.

3. The apparatus as recited in claim 2, wherein said queue stores an IP packet payload, a DH (Destination Header) as a destination IP address value of the IP packet, and an EH (Encapsulated Header) as encapsulation header information stuck when the IP is encapsulated, as the main fields of the IP packet.

4. A method for dispersively processing an IP (Internet Protocol) packet forwarding, in an IP packet forwarding dispersion processing apparatus for supporting a quality of service (QoS), said method comprising the steps of:
a) classifying reception IP packets according to the QoS and storing them at an input-side class queue;
b) searching a forwarding information base by using an exact matching table and an LPM (Longest Prefix Matching) search table according to an IP header value of the IP packet stored at the input-side class queue, and gaining forwarding information;
c) transferring the IP packet according to the gained forwarding information;
d) classifying the transferred IP packets according to the QoS, and storing them at an output-side class queue; and
e) outputting the IP packet stored at the output-side class queue according to the QoS.

5. The method as recited in claim 4, wherein said step b) includes the steps of:
b1) carrying the forwarding information out of the forwarding table by using an output address of the exact matching table, according to the searching result for the exact matching table, and after that, encapsulating the IP packet and transferring it to a next-hop; and
b2) carrying the forwarding information out of the forwarding table by using the output address of the LPM matching table, according to the searching result for the LPM matching table, and after that, encapsulating the IP packet and transferring it to the next-hop, and simultaneously, registering the LPM matching result for the exact matching searching table.

6. The method as recited in claim 5, wherein said queue stores an IP packet payload, a DH (Destination Header) as a destination IP address value of the IP packet, and an EH (Encapsulated Header) as encapsulation header information stuck when the IP is encapsulated, as the main fields of the IP packet.

7. A record medium capable of being read through a computer having a writing of a program, in an IP packet forwarding dispersion-processing apparatus having a processor, said record medium characterized in that said program is provided to realize:
a first function of classifying reception IP packets according to a QoS and storing them at an input-side class queue;
a second function of searching a forwarding information base by using an exact matching table and an LPM (Longest Prefix Matching) search table according to an IP header value of the IP packet stored at the input-side class queue, and gaining forwarding information;
a third function of transferring the IP packet according to the gained forwarding information;
a fourth function of classifying the transferred IP packets according to the QoS, and storing them at an output-side class queue; and
a fifth function of outputting the IP packet stored at the output-side class queue according to the QoS.
